(19) United States
(12) Patent Application Publication
(10) Pub. No.: US 2012/0016913 A1
(43) Pub. Date: Jan. 19, 2012

(54) USING XML TO RUN TESTS IN A MULTI-TENANT DATABASE ENVIRONMENT

(75) Inventors: Steven Tamm, San Francisco, CA (US); Walter Macklem, San Francisco, CA (US)

(73) Assignee: SALESFORCE.COM, INC., San Francisco, CA (US)

(21) Appl. No.: 12/836,433

(22) Filed: Jul. 14, 2010

(51) Int. Cl. G06F 17/30

(52) U.S. Cl. 707/805; 707/E17.005

(57) ABSTRACT

A method for using extensible markup language (XML) for testing a process in a multi-tenant database system is disclosed. The method includes providing a user interface (UI) for a user of the multi-tenant database system, receiving the process for testing via the UI, where the process is created using the UI, receiving an indication from the UI that an XML file is to be extracted for testing the process, and extracting the XML file in response to the received indication, where the XML file is usable for testing the process. Further, sample data for the process can also be created and received. In addition, modifications of the XML file from the user via the UI can be done, the XML file can be executed for testing the process.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to programming tests for testing modules in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. Unfortunately, conventional database module testing approaches may not facilitate testing of various database usage processes.

### BRIEF SUMMARY

In accordance with embodiments, provided are mechanisms and methods for using extensible markup language (XML) to run tests in a multi-tenant database environment. These mechanisms and methods for using XML to run tests in a multi-tenant database environment can enable embodiments to provide a user interface (UI) for a user of the multi-tenant database system. Particular embodiments include receiving via the UI, a process for testing, where the process is created using the UI, receiving an indication from the UI that an XML file is to be extracted for testing the process, and extracting the XML file in response to the received indication, where XML file is usable for testing the process.

In an embodiment and by way of example, a method for using XML to run tests in a multi-tenant database environment is provided. The method includes providing a UI for a user of the multi-tenant database system, receiving via the UI the process for testing, where the process is created using the UI, receiving an indication from the UI that an XML file is to be extracted for testing the process, and extracting the XML file in response to the received indication, where XML file is usable for testing the process.

While the present invention is described with reference to an embodiment in which techniques for using XML to run tests in a multi-tenant database environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of an environment wherein an on-demand database service might be used;

FIG. 2 illustrates a block diagram of an embodiment of elements of FIG. 1 and various possible interconnections between these elements;

FIG. 3 illustrates an example simplified flow diagram for creating and using a test program for a multi-tenant database system; and

FIG. 4 illustrates a more detailed flow diagram of the flow diagram exemplified in FIG. 3.

### DETAILED DESCRIPTION

### General Overview

Systems and methods are provided for using XML to run tests in a multi-tenant database environment.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for using XML to run tests in a multi-tenant database environment will be described with reference to example embodiments.

### System Overview

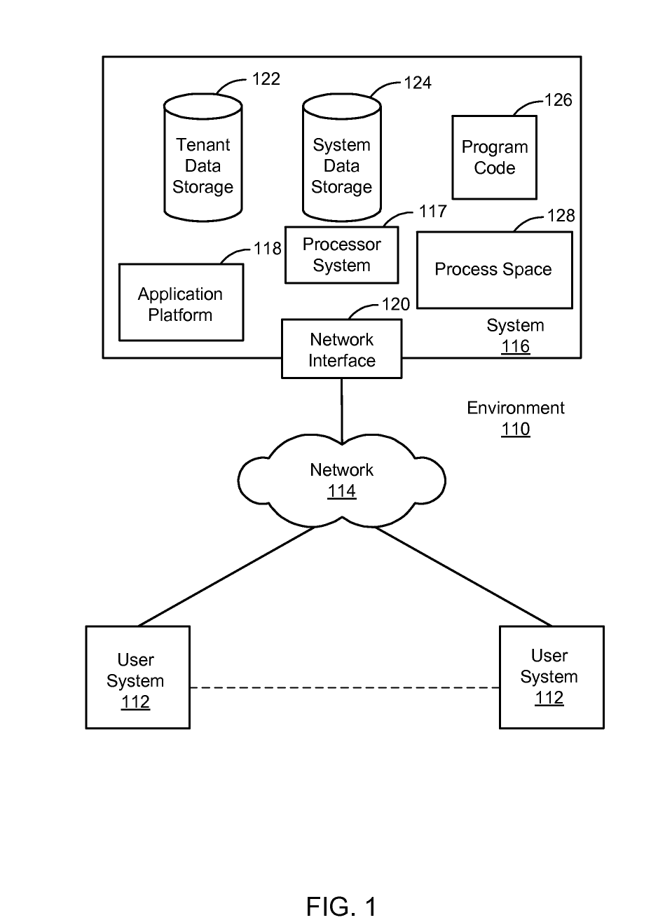

FIG. 1 illustrates a block diagram of an environment 110 wherein an on-demand database service might be used. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

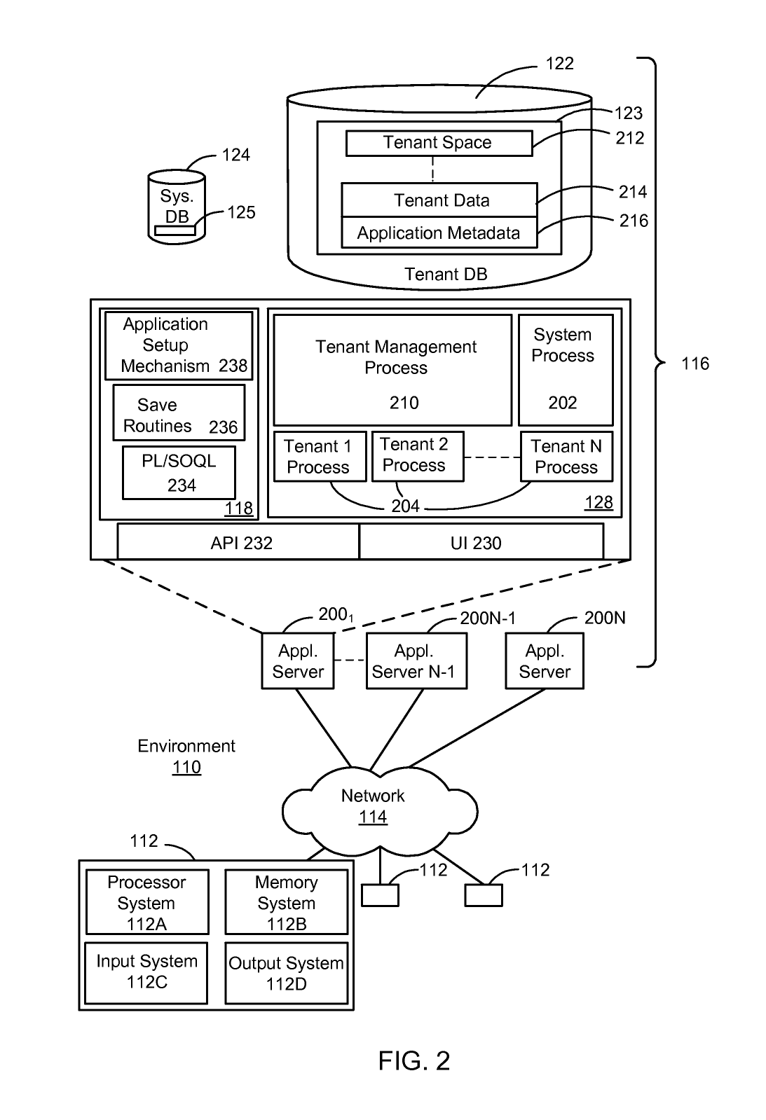

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 2) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein. A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system 112 has the capacities allotted to that salesperson. However, while an administrator is using that user system 112 to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 16 may provide tenant access to multiple hosted (standard and custom) applications, including a CRM application. User (or third party developer) applications, which may or may not include CRM, may be supported by application platform 118, which manages creation, storage of the applications into one or more database objects and executing of the applications in a virtual machine in the process space of system 116.

One arrangement for elements of system 116 is shown in FIG. 1, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical disks, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110. However, in FIG. 2 elements of system 116 and various interconnections in an embodiment are further illustrated. FIG. 2 shows that user system 112 may include processor system 112A, memory system 112B, input system 112C, and output system 112D. FIG. 2 shows network 114 and system 116. FIG. 2 also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown by FIG. 2, system 116 may include a network interface 120 (of FIG. 1) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data 123 and the system data 125 may be stored in various databases, such as one or more Oracle™ databases.

Application platform 118 includes an application setup mechanism 238 that supports application developers creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 234 that provides a programming language style interface extension to API 232. Invocations to applications may be detected by one or more system processes, which manages retrieving application metadata 216 for the subscriber making the invocation and executing the metadata as an application in a virtual machine.

Each application server 200 may be communicably coupled to database systems, e.g., having access to system data 125 and tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

### Example XML Test Runner

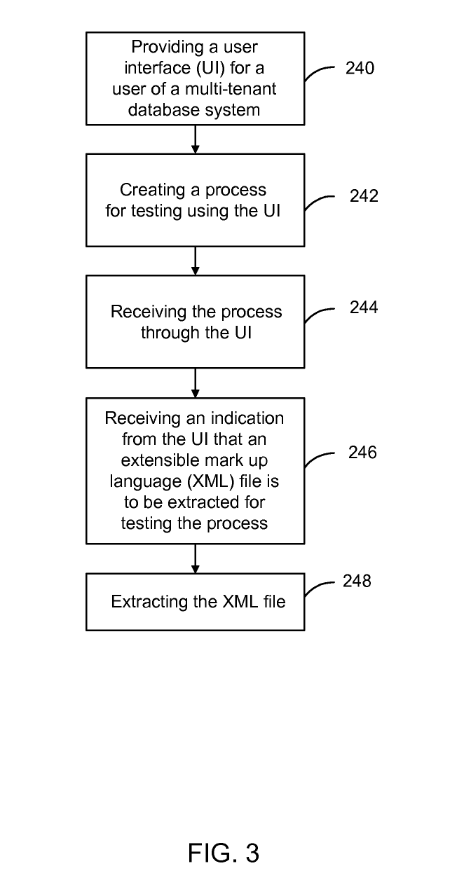

Referring now to FIG. 3, shown is an example simplified flow diagram of a method for using extensible markup language (XML) for testing a process in a multi-tenant database system. A user interface (UI) can be provided for a user of the multi-tenant database system, as indicated at block 240. The process for testing may be created using the UI, as indicated at block 242, and the process may be received via the UI as shown in block 244. An indication from the UI (e.g., by way of the user pressing a button, or any other suitable indication, etc.) that an XML file is to be extracted for testing the process may be received, as indicated at block 246. Finally, the XML file in response to the received indication can be extracted, as indicated at block 248.

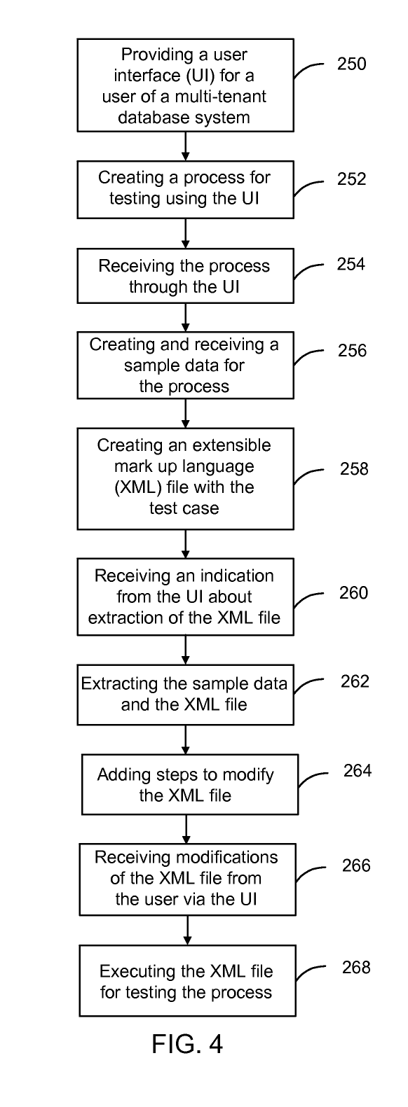

Referring now to FIG. 4, shown is a more detailed flow diagram of the example shown in FIG. 3. The UI is provided for the user of the multi-tenant database system, as indicated at block 250. The process in the multi-tenant database system for testing can be created using the UI as indicated at block 252, and the process may be received via the UI, as shown in block 254. Sample data for the process may also be created and received, as indicated at block 256. An XML file may created with the test case (e.g., based on the user-entered process), as indicated at block 258, and the indication from the UI that the XML file is to be extracted for testing the process may be received, as indicated at block 260. The sample data and the XML file can be extracted as shown in block 262. Several steps may also be added to modify the XML file, as indicated at block 264, and such modifications of the XML file from the user via the UI can be received, as indicated at block 266. The modifications may be specific to a particular process and/or a tenant/user (e.g., an organization having a deployed module), and can include additional steps to be performed in the process for the tenant. The XML file can then be executed for testing the process, as shown in block 268.

The method for using XML for testing the process in the multi-tenant database system described in FIGS. 3 and 4 can utilize, e.g., an “Xml Test Runner” written in XML to write an “ftest.” The XML may itself describe actions to perform to the Xml Test Runner. The Xml Test Runner in ftest can pre-initialize an organization (e.g., a tenant or company) with metadata without needing to DOT or perform other such setup work.

The Xml Test Runner may be available for use in ftests. The XML file may be specified load when the organization is initially created in the TenantParameters, and can pick the first testcase and execute it right after creating the organization. Then, tests that use that Test Config Key can rely on that metadata existing without any other ftestSetup. In an ftest's initializer, the TenantParameters may be created and return the preload script file name. An example from the constructor of User License Definition is:

setOrganizationParameters(“TestName”, OrgEdition.ENTERPRISE_EDITION, “CallCenterTest.xml”);

When the organization is created, steps may be executed at that in the first testcase in that file. When a test is re-run in a development mode, the data may not be reloaded.

In the particular example of FIGS. 3 and 4, an Xml Importer tool may be utilized for importing the metadata into a remote instance. The Xml Importer tool can be used to call a private API that will load metadata into an organization, e.g., using the Xml Serialization format. The target organization may have private API enabled. The Xml Importer can be a command line utility designed to connect to an “Sfdc” instance and load the metadata from one or more XML files.

The XML files can be relative to a source directory. The XML files can be reused in multiple steps if there are different test cases in the same file to be invoked. The environment state may not be shared between invocations, reducing a need to re-query for any objects created in a previous test case. When invoked, it will go through each XML file in order and run the steps in the associated test case. Most such steps can be run multiple times and the data can be inserted or updated as appropriate.

A set of ant build scripts can be used to compile and run the Xml Importer, e.g., using the Cross Instance Wsdl to connect to the target and perform the actions. The Wsdl itself can, e.g., return the IDs associated with the XmlSerEnv for each step.

In the particular example of FIGS. 3 and 4, XmlTestSteps can be used to test the process in a multi-tenant database system. XmlTestSteps may include default set of steps and set of steps available in tests. For example, such default a set of steps may include:

(1) Custom Object to create a custom object and its associated fields, record types, and layout;

(2) Custom Fields to create custom fields on a standard object;

(3) Custom Page to create custom home page layout consisting of home page components;

(4) Users to specify users to perform operations, create groups and queue;

(5) Create to create records using the Soap API format;

(6) Update to update records using the Soap API format;

(7) Delete to delete one or more records based on id;

(8) Undelete to delete one or more records based on id;

(9) Apex to execute anonymous Apex;

(10) Compile to compile Apex Triggers and Classes;

(11) CompileAndTest to compile Apex Triggers and Classes and run tests;

(12) Package to create an App Exchange package;

(13) WorkflowRule to create a workflow rule and associated actions;

(14) ProcessDef to create an approval process;

(15) CustomApp to create a Custom App (Tabset);

(16) Query to invoke a query;

(17) Deploy to deploy a package using the metadata API; and

(18) Metadata to upsert metadata objects using the metadata API.

Example steps available in tests can include:

(1) Activate, ActivateFail to activate a Contract or Order using the API;

(2) Assert Email to assert the number and contents of emails send;

(3) Assert Result, AssertResultFail to assert the size and contents of a Soap query;

(4) Change Owner, ChangeOwnerFail to change the owner of a record using the same method as the UI;

(5) Lock, Unlock to lock or unlock an entity (e.g., in workflow);

(6) Merge, MergeFail to perform a merge as in the UI;

(7) Create Fail, UpdateFail, DeleteFail to assert that creating, updating, or deleting a record should fail;

(8) Set Org Perm to set an org permission for the duration of the test;

(9) Process, ProcessFail to submit a record for approval, or approve or reject a work item;

(10) Apex Fail, CompileFail, CompileAndTestFail to assert that executing apex or compiling a package or trigger should fail;

(11) Set Org Sharing to set the default rules for sharing an entity;

(12) Set User Perm to clone the profile of a user and set a perm on it;

(13) Lead Convert, LeadConvertFail to convert a lead;

(14) Sql to execute random bits of Sql;

(15) Default User to set the default user to use for subsequent create and reject steps;

(16) Assignment Info to set the default assignment info for Leads or Cases;

(17) Delegate Group to set a delegate group;

(18) Set History to set the field history tracking on an entity;

(19) Workflow Time Queue Process to run the workflow time queue process; and

(20) Run Tests to run apex tests in the organization.

Particular example test steps for a browser-based test can include:

(1) Open to open a URL;

(2) Click to click a button;

(3) Click And Wait to click a button and wait for the page to load;

(4) Select to select an option;

(5) Select And Wait to select an option and wait for the page to load;

(6) Assert Text to assert that certain text is present or absent on the page, or in a particular element;

(7) Assert Element to assert that an element is present or not; and

(8) Assert Location to assert the current URL in browse.

The particular example described in FIGS. 3 and 4 may utilize an Import UI tool to access an import screen, and the organization may have the Private API turned on. Example functions used by such an Import tool can include:

(1) Case name is the name attribute of the test case you are executing;

(2) Test mode used to create the objects in the XML and then delete them thereafter;

(3) Results: After saving, the ID keys placed in the file can be listed here with the associated object ID;

(4) XML File to select the XML file that contains the XML steps; and

(5) Copy XML in here (e.g., up to 100K xml text).

For enabling Export UI, an organization have both the DOT enabled, and Private API permissions turned on. For example, a UI page can allow a user to enter various identifiers, for use as discussed below:

(1) Object identifier: for any object in the system, and can generally product a <Create> step, except when one of the special entities listed below. If it is a normal API object, it will try to follow the required foreign keys and emit those as well (so specifying a detail object will automatically emit the parent object).

(2) API object name: may create the <Custom Object> or <Custom Fields> step for that object containing the fields, record types, and validation formulas for that object.

(3) API object name prefixed with layouts: can create the <Custom Fields>step for that object containing all of the Layouts defined for that org, including the layout/profile/record type mapping. It also may include the List Layouts (e.g., lookup, search layouts, etc.).

(4) API object name prefixed with FLS: can create the <Field Security> step for that object containing the Field Level Security and CRUD mapping for all the existing profiles.

(5) API object name prefixed with RT: can create the <Custom Fields> step for that object to specify the record types associated with the object, including the profile mapping. Example special objects include workflow rules, layouts, record types, and custom object definition, to name just a few.

An XML framework may also be used to write any suitable browser-based tests. The type of the browser on the testCase or in the testRunner may be specified, and a comma delimited set of browsers can also be employed. To run the steps from inside such a browser-based test, a user can create an XmlBrowserTestRunner and make the test a subclass BrowserTest, and the browsers used may be those defined in the test.

An example of browser-based test steps is illustrated below:

<testcase name=“SimpleRename” browserTypes=“Firefox”>
<CustomObject id=“custObj” name=“RenameTest”
users=“su,r1,r11,r2,r21”

tabMotif=“Globe” tabId=“tabId”

keyPrefix=“keyPrefix” standardApps=“SALESFORCE”/>
<Open url=“/ui/setup/RenameTabPage”/>
<SelectAndWait what=“1” option=“label=English”/>
<ClickAndWait what=“edit{#custObj}”/>
<Click what=“StartsWith”/>
<Type where=“nf” text=“Puppy Name”/>
<Type where=“val_n-0-0” text=“Puppy”/>
<Type where=“val_n-3-0” text=“Puppies”/>
<ClickAndWait what=“save”/>
<!-- Make sure it renamed the tab -->
<AssertElement present=“edit{#custObj}”/>
<!-- Do it in Spanish -->
<SelectAndWait what=“1” option=“label=Spanish”/>
<ClickAndWait what=“edit{#custObj}”/>
<Type where=“nf” text=“Nombre de cachorro”/>
<Select what=“Gender” option=“label=Masculine”/>
<Type where=“val_n-0-0” text=“Cachorro”/>
<Type where=“val_n-3-0” text=“Cachorros”/>
<ClickAndWait what=“save”/>
<AssertElement present=“edit{#custObj}”/>
<!-- Try it in english -->
<Open url=“/home/home.jsp”/>
<AssertText present=“Puppies”/>
<AssertText present=“Puppies”
where=“//a[@href=‘/{#keyPrefix}/o’]”/>
<ClickAndWait what=“//a[@href=‘/{#keyPrefix}/o’]”/>
<AssertText present=“Recent Puppies”/>
<ClickAndWait what=“new”/>
<AssertText present=“Puppy Name;Puppy Edit”/>
<!-- Switch to Spanish -->
<Users>
<User id=“spanishUser” profile=“Standard” userRole=“R5”/>
</Users>
<Update>
<User>
<Id>{#spanishUser}</Id>
<LanguageLocaleKey>es</LanguageLocaleKey>
</User>
</Update>
<Open url=“/home/home.jsp” user=“spanishUser”/>
<AssertText present=“Cachorros”/>
<AssertText present=“Cachorros”
where=“//a[@href=‘/{#keyPrefix}/o’]”/>
<ClickAndWait what=“//a[@href=‘/{#keyPrefix}/o’]”/>
<AssertText present=“Cachorros recientes”/>
<ClickAndWait what=“new”/>
<AssertText present=“Nombre de cachorro;Modificar Cachorro”/>
</testcase>

In an example XML test runner, identifiers may also be resolved. For example, when an identifier or “ID” attribute is placed on elements inside a create tag, after the object is created, the ID for that object can be inserted into a hash table at that ID. Reference to that object ID can be made by using the hash key that is subsequently specified on the ID attribute, or by utilizing “{#accId}”, or the like. As shown in the example XML test runner below, “{#su}” can be used to perform a substitution for a previously created or referenced object in this manner.

<testrunner>
<setup>
<Users>
<User id=“r1” profile=“Standard” userRole=“R1”/>
</Users>
</setup>
<testcase name=“Example”>
<Create user=“{#su}”>
<Lead id=“lead”>
<Street>spear</Street>
<Company>Test Workflow</Company>
<LastName>Lead WWW</LastName>
</Lead>
</Create>
<!-- Make sure the owner was assigned correctly -->
<AssertResult query=“select OwnerId,Id from Lead where id=‘{#lead}’”
size=“1”>
<Lead>
<OwnerId>{#su}</OwnerId>
</Lead>
</AssertResult>
</testcase>
</testrunner>

The main tags for this example may be setup and testcase. The particular test case can also consider setup actions that are run before each test, and any objects created are removed after each test case. A dot attribute may also be added to the setup tag to specify the dot to use with the given organization.

The set of tags that can be included inside a testcase are Users, Create, Update, CreateFail errorCode, UpdateFail, Delete dead, DeleteFail exceptionCode, AssertResult query, Process user, WorkflowRule, CustomObject name, CustomFields entity.

In addition, example custom field optional values can include:

(1) length: length of the text field;

(2) digitsToLeft: number of digits to the left of the decimal point to use;

(3) scale: the scale (number of decimal places);

(4) format: auto number format;

(5) numLines: number of lines to display for multi-select picklist and text area;

(6) formula: value of the custom field (the type may be the type of the field);

(7) users: users whose profiles will be modified to see/use the given fields;

(8) default: value of the default value: true or false for boolean, or a formula;

(9) required: true if the field should be required; and

(10) relLabel: The label for the related list.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for using extensible markup language (XML) for testing a process in a multi-tenant database system, the method comprising:
providing a user interface (UI) for a user of the multi-tenant database system;
receiving via the UI, the process for testing, wherein the process is created using the UI;
receiving an indication from the UI that an XML file is to be extracted for testing the process; and
extracting the XML file in response to the received indication, wherein the XML file is usable for testing the process.

2. The method of claim 1, further comprising receiving modifications of the XML file from the user via the UI, wherein the modifications are specific to a tenant of the user.

3. The method of claim 2, wherein the modifications comprise additional steps to be performed in the process for the tenant.

4. The method of claim 1, further comprising executing the XML file for testing the process.

5. The method of claim 1, further comprising receiving sample data for the process for testing, wherein the extracting the XML file also extracts the sample data.

6. A computer-readable storage medium having one or more instructions thereon for using extensible markup language (XML) to run tests in a multi-tenant database system, the instructions when executed by one or more processors causing the one or more processors to carry out:
providing a user interface (UI) for a user of the multi-tenant database system;
receiving via the UI, the process for testing, wherein the process is created using the UI;
receiving an indication from the UI that an XML file is to be extracted for testing the process; and
extracting the XML file in response to the received indication, wherein the XML file is usable for testing the process.

7. The computer-readable storage medium of claim 6, further comprising receiving modifications of the XML file from the user via the UI, wherein the modifications are specific to a tenant of the user.

8. The computer-readable storage medium of claim 7, wherein the modifications comprise additional steps to be performed in the process for the tenant.

9. The computer-readable storage medium of claim 6, further comprising executing the XML file for testing the process.

10. The computer-readable storage medium of claim 6, further comprising receiving sample data for the process for testing, wherein the extracting the XML file also extracts the sample data.

11. An apparatus for using extensible markup language (XML) to run tests in a multi-tenant database, the apparatus comprising:
a processor; and
one or more stored sequences of instructions which, when executed by the processor, cause the processor to carry out:
providing a user interface (UI) for a user of the multi-tenant database system;
receiving via the UI, the process for testing, wherein the process is created using the UI;
receiving an indication from the UI that an XML file is to be extracted for testing the process; and
extracting the XML file in response to the received indication, wherein the XML file is usable for testing the process.

12. The apparatus of claim 11, further comprising receiving modifications of the XML file from the user via the UI, wherein the modifications are specific to a tenant of the user.

13. The apparatus of claim 12, wherein the modifications comprise additional steps to be performed in the process for the tenant.

14. The apparatus of claim 11, further comprising executing the XML file for testing the process.

15. The apparatus of claim 11, further comprising receiving sample data for the process for testing, wherein the extracting the XML file also extracts the sample data.
